(19) United States
(12) Patent Application Publication
(10) Pub. No.: US 2005/0236796 A1
(43) Pub. Date: Oct. 27, 2005

(54) Vehicle suspension system

(76) Inventor: Timothy Halonen, Cokato, MN (US)

Correspondence Address: NEIL J. COIG, 2355 DRUSILLA LANE, BATON ROUGE, LA, 70809, US

(21) Appl. No.: 10/833,756

(22) Filed: Apr. 27, 2004

(51) Int. Cl. B60G 9/02; B60G 1/00

(52) U.S. Cl. 280/124.128

(57) ABSTRACT

A suspension system capable of lowering a vehicle chassis for flush contact with the ground beneath the vehicle, the suspension system comprising separate assemblies attaching each vehicle wheel to the chassis, each assembly having a front connection that is detachable from the chassis to permit the lowering of the chassis to the ground and having a pivoting rear connection to permit the chassis to be positioned beneath the vehicle.

### BACKGROUND OF THE INVENTION

1. Field of the Invention

This invention relates in general to vehicle suspension systems, and more particularly to suspension systems utilized on trailers and other similar vehicles.

2. Prior Art

There are many instances where it is desirable to lower a trailer or similar vehicle in contact with the ground, or to raise it to avoid contact with objects on the ground. Such lowering in many instances increases the ease in loading the trailer or for the addition or removal of a portion of the trailer. In other instances the lowering of the trailer increases its stability if there is a platform attached to the trailer that is to be raised. In being able to raise the trailer one can avoid damage to the trailer resulting from contact with objects on the ground.

There are lowering systems that place a substantial portion of the trailer in contact with the ground. Examples of such systems are illustrated in U.S. Pat. Nos. 5,308,213 and 6,113,130, as well as Swiss Patent 449436. It is also known to have separate suspension assemblies for each wheel that are united for disengagement from the vehicle chassis to permit the chassis to be lowered to the ground. Examples of such assemblies are illustrated in U.S. Pat. Nos. 3,788,675, 4,659,100, 5,474,416, 5,906,470 and 6,520,521. However, there remains a need for less complex and more inexpensive suspension systems that can be used to lower a trailer to the ground. There is also a need for a suspension system that permits both the lowering and the raising of the vehicle.

### OBJECTS AND SUMMARY OF THE INVENTION

Therefore, one object of this invention is to provide an improved suspension system for lowering or raising a trailer or similar vehicle in relation to the ground

Another object of this invention is to provide an improved suspension assembly that is less expensive to construct and easy to operate

Still another object of this invention is to provide an improved suspension assembly that can operate independent of other suspension assemblies that may be utilized with the trailer or similar vehicle.

Other objects and advantages of this invention shall become apparent from the ensuing descriptions of the invention.

Accordingly, a suspension assembly is taught that comprises an elongated attachment member having first and second end sections, a leverage arm having first and second leverage arm end sections affixed to the attachment member having its second leverage arm end section extending in the direction of and at an angle to and in substantially the same plane as the first end section of the attachment member. The suspension assembly further comprising a wheel axle support bar. The bar is connected to and pivots about the second leverage arm end section. It further comprises a suspension member extending substantially perpendicularly from the support bar in a direction toward the chassis. The suspension member has a length sufficient to permit the suspension member to be affixed to the vehicle chassis and provide the desired suspension characteristics. In a preferred embodiment the suspension member will be constructed at least in part from an elastomeric composition. In another preferred embodiment the elongated attachment member and the leverage arm will be fixed to a wheel well. In still another preferred embodiment a wheel axle will extend substantially perpendicularly from the support bar and into the interior of the wheel well.

### BRIEF DESCRIPTION OF THE DRAWINGS

The accompanying drawings illustrate a preferred embodiment of this invention. However, it is to be understood that this embodiment is not intended to be exhaustive, nor limiting of the invention. They are but examples of some of the forms in which the invention may be practiced.

FIG. 1 is a top view of the vehicle chassis having a suspension assembly for each of the two wheels.

FIG. 2 is a three-quarter front perspective view of one preferred embodiment of the suspension assembly used on each wheel of the vehicle.

FIG. 3 is a three-quarter front perspective view of the suspension assembly of FIG. 2 from the back side of the suspension assembly.

FIG. 4 is a front view of the suspension assembly of FIG. 1.

FIG. 5 is a top view of the suspension assembly of FIG. 1.

FIG. 6 is side view of the suspension assembly of FIG. 1.

### PREFERRED EMBODIMENTS OF THE INVENTION

Without any intent to limit the scope of this invention, reference is made to the figures in describing the preferred embodiments of the invention.

For purposes of describing the invention vehicle means any moving device having a chassis supported on wheels. Examples of such vehicles include trailers, wagons and carts, whether self-propelled or propelled by another motorized vehicle, such as a car or truck.

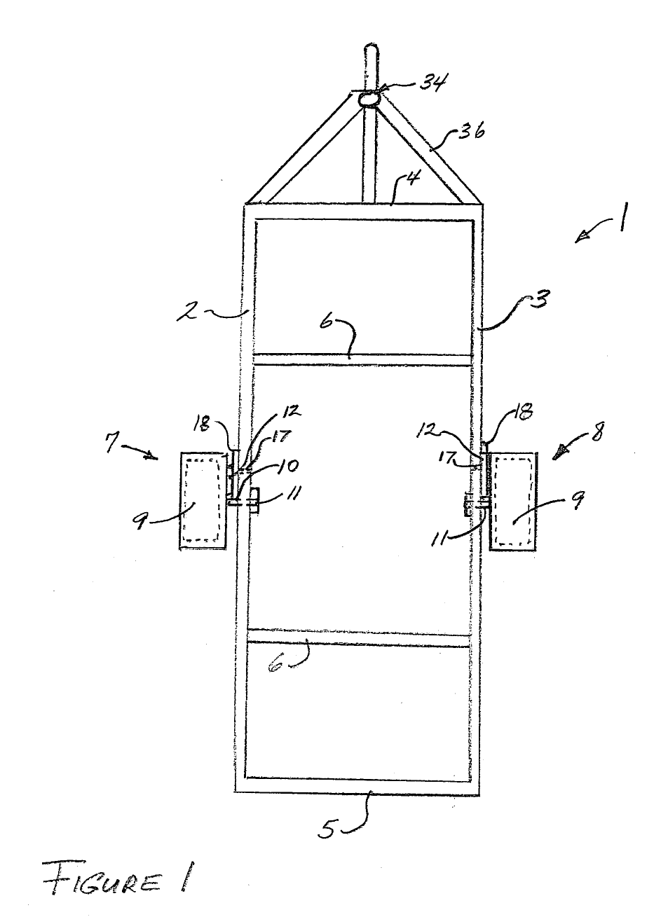

Referring to FIG. 1, chassis 1 is constructed of parallel, spaced apart side channel iron rails 2 and 3 or similar support structures and two parallel end channel iron rails 4 and 5 fixed to the ends of rails 2 and 3 to form rectangular-shaped chassis 1. Multiple support rails 6 can be fixed at each of their opposite ends to rails 2 and 3 to add rigidity and structural integrity to chassis 1. The chassis can be constructed to be of different shapes. Opposing wheel assemblies 7 and 8 are mounted to rails 2 and 3, respectively. Each wheel assembly comprises a wheel 9 mounted on an axle 10 for rotation.

In one aspect of this invention the suspension assembly 11 is utilized to affix the wheel assembly 7 to the chassis 1. In a preferred embodiment each of the suspension assemblies 11 comprise an attachment member 12 having first and second end sections 13 and 14 respectively. The first end section 13 is attached to suspension member 15 in a manner to permit attachment member 12 to pivot about suspension member 15. The second end section 14 is provided with an opening 16 that is aligned to a corresponding opening 17 in the adjacent rail 2 or 3 to permit the second end section 14 to be affixed to the rail. A leverage arm 18 having first and second leverage arm end sections 19 and 20, respectively, to permit first leverage arm end section 19 to be fixed in position at an angle “A” relative to leverage arm 18 and in the same vertical plane as attachment member 12. The second leverage arm end section 20 extends a sufficient distance to permit the attachment of cables (not shown) or to be gripped to lift or lower attachment member 12. Suspension member 15 extends substantially perpendicularly to attachment member 12 in the direction of and is affixed to the adjacent rail 2 or 3. In a preferred embodiment suspension member 15 is constructed at least in part of elastomeric material. In a more preferred embodiment the material has a flexibility of approximate 60 to 90 durometers, most preferably an approximate 80 durometers. The selection of the material to be used and the length of suspension member 14 can vary depending on the suspension characteristics desired and the size and weight of the vehicle chassis and anticipated load the chassis is to carry.

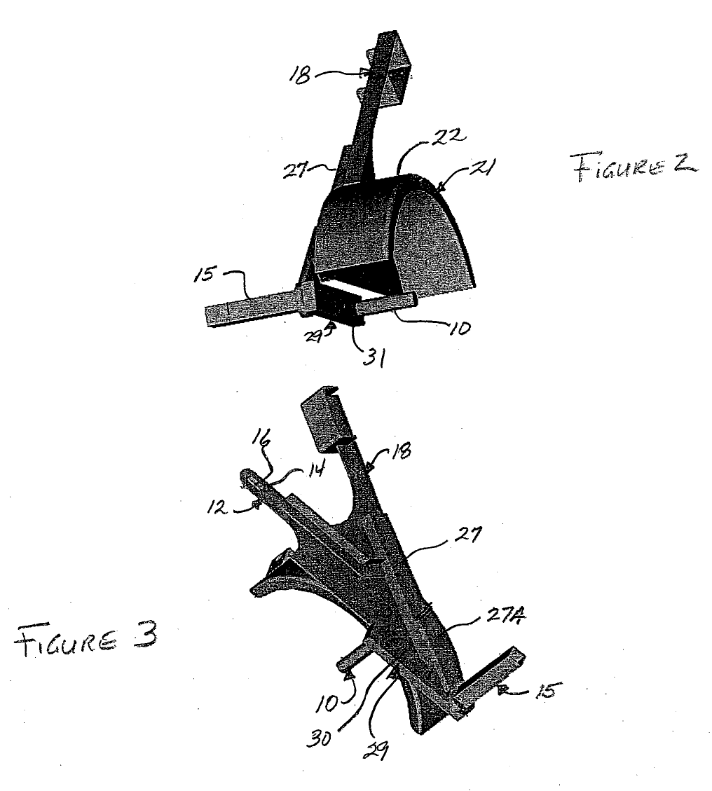

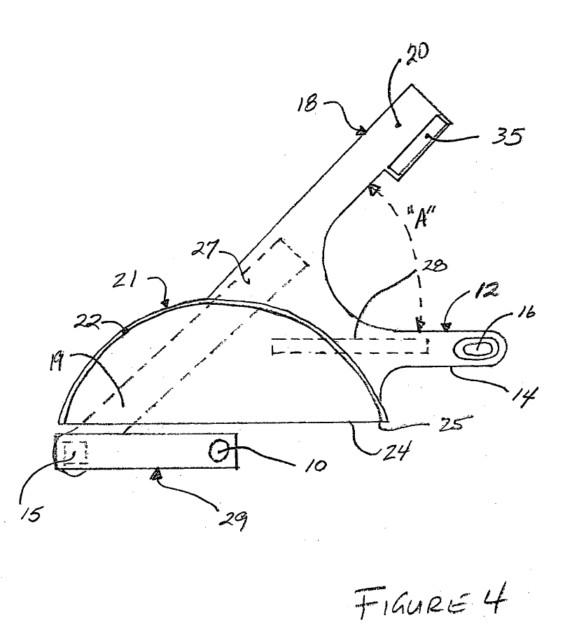

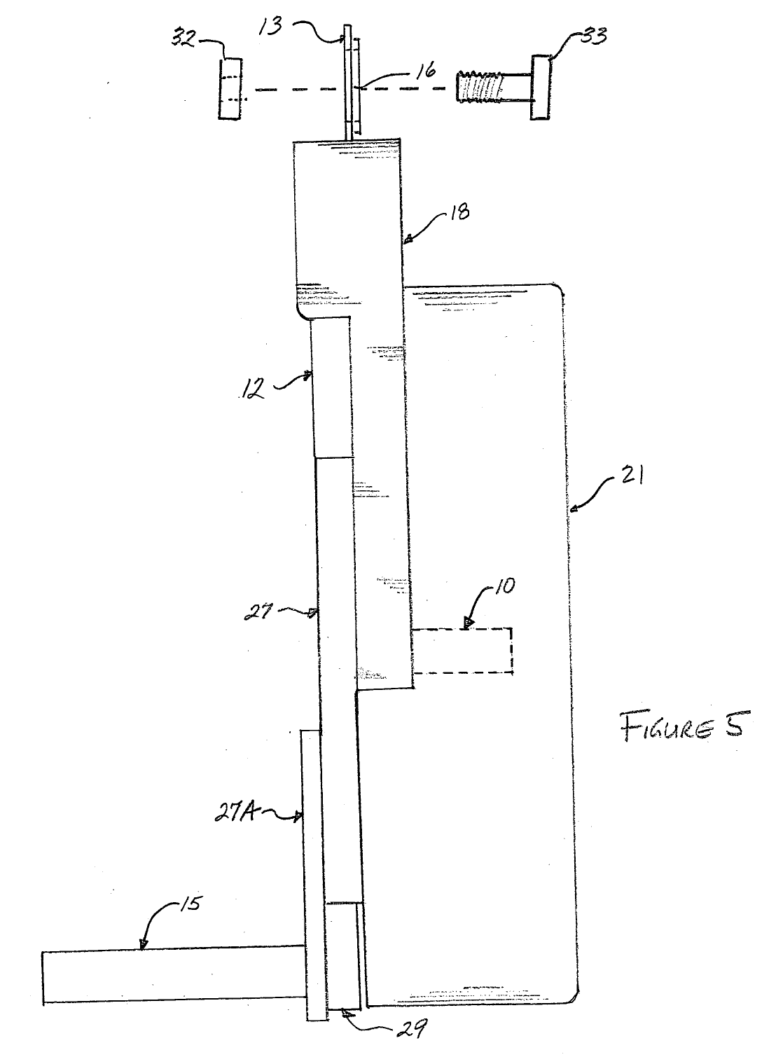

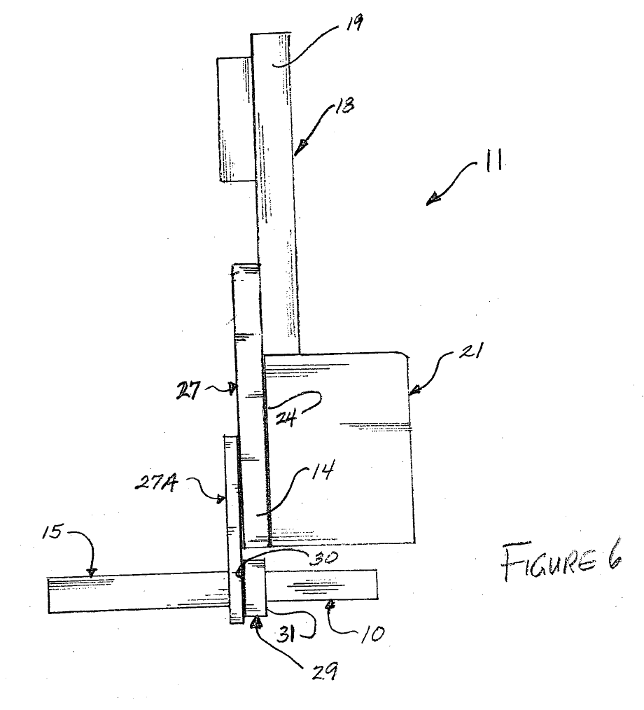

Turning now to the FIGS. 2-6 a particularly preferred embodiment of the invention is disclosed that incorporates the use of wheel well housing 21. Wheel well housing 21 comprises an arcuate-shaped metal sheet 22 that fits over wheel 9. It also comprises rear metal panel 24 that is affixed along one edge 25 of sheet 22 and extends down to a position above wheel axle 10. In this embodiment both attachment member 12 and leverage arm 18 are formed from panel 24, or alternatively, are welded to panel 24. If they are formed as part of panel 24 reinforcement bars 27 and 28, respectively, can be welded to provide additional structural support and rigidity. Suspension member 15 extends substantially perpendicularly from one side 30 of wheel axle support bar 29. Wheel axle 10 extending substantially perpendicularly from the opposite side 31 of wheel axle support bar 29. Bar 29 is positioned from wheel well housing panel 24 by reinforcement extension strip 27A to cause wheel 9 to be properly positioned in wheel well housing 21.

During normal use suspension assemblies 7 or 8 are fixed on their respective rails 2 and 3. This is achieved by bolting or otherwise securing second end section 14 to the adjacent rail. When it is desired to lower chassis 1 to the ground, nut 32 is unscrewed from bolt 33. If a cable is to be used to pull up on leverage arm 18, then the cable is attached to the second leverage arm end section 20 by attaching a conventional connecting member to an eyebolt or opening 35 in the second leverage arm end section 20. The cable is made taunt to take the load off of bolt 33 to permit its easy removal from opening 16. If it is desired to lower chassis 1 the cable is fed out to permit chassis 1 to be lowered. On the other hand if it is desired to raise chassis 1, the cable is cranked up to raise leverage arm 18 which then results in chassis 1 being raised.

Any type of conventional cable pulling system can be used. One example would include a pulley having a manual or motor driven cable reel mounted atop of a vertical post 34 extending vertically up from the chassis 1 or the tongue 36 that affixes the chassis to a car or truck.

There are of course other alternate embodiments which are obvious from the foregoing descriptions of the invention which are intended to be included within the scope of the invention as defined by the following claims.

1. A suspension assembly attached to a vehicle chassis comprising:
(a) an elongated attachment member having first and second end sections, the first end section being pivotly attachable to the vehicle chassis, the second end section having an opening therein for use in attaching the elongated member to the vehicle chassis,
(b) a leverage arm having first and second leverage arm end sections, the first leverage arm end section being affixed to the attachment member, the second leverage arm end section extending in the direction of and at an angle to and in substantially in the same plane as the attachment member, and
(c) a suspension member extending substantially perpendicularly from the attachment member in a direction to permit the suspension member to be affixed to the vehicle chassis.

2. A suspension assembly according to claim 1 wherein the suspension member comprises an elastomeric member.

3. A suspension assembly according to claim 1 wherein
(a) the first elongated attachment member end section being affixed to a wheel well housing with its second end section extending beyond the wheel well housing,
(b) the first leverage arm end section being affixed to the wheel well housing with the second leverage arm end section extending beyond the wheel well housing, and
(c) a wheel axle support bar affixed to the suspension member and pivotly connected to the leverage arm at the second leverage arm end section.

4. A suspension assembly according to claim 3 further comprising a wheel axle attached to the support bar and extending substantially perpendicularly from said support bar into the wheel well.

5. A suspension system attached to a vehicle chassis comprising:
(a) a first elongated attachment member having first and second end sections, the first elongated attachment member being affixed at the first end section to a wheel well with its second end section extending beyond the wheel well, the second end section having an opening therein for use in attaching the first elongated member to the vehicle chassis,
(b) a leverage arm having first and second leverage arm end sections, the first leverage arm end section being affixed to the wheel well, the second leverage arm end section extending beyond the wheel well in the direction of and at an angle to and in substantially in the same plane as the first attachment member,
(c) a wheel axle support bar having a wheel axle extending substantially perpendicularly from said support bar and extending into the wheel well, the wheel axle support bar pivotly connected to the leverage arm at the second leverage arm end section, and
(d) a suspension member extending substantially perpendicularly from said support bar in a direction substantially opposite the wheel axle a distance to permit the suspension member to be affixed to the vehicle chassis.
